(19) United States
(12) Patent Application Publication
(10) Pub. No.: US 2007/0240141 A1
(43) Pub. Date: Oct. 11, 2007

(54) Performing dynamic information flow tracking

(76) Inventors: Feng Qin, Urbana, IL (US); Cheng Wang, San Jose, CA (US); Ho-Seop Kim, Portland, OR (US); Yuanyuan Zhou, Urbana, IL (US); Youfeng Wu, Palo Alto, CA (US)

Correspondence Address: TROP PRUNER & HU, PC, 1616 S. VOSS ROAD, SUITE 750, HOUSTON, TX, 77057-2631, US

(21) Appl. No.: 11/394,287

(22) Filed: Mar. 30, 2006

(51) Int. Cl. G06F 9/45; G06F 9/44

(52) U.S. Cl. 717/158; 717/155; 717/130

(57) ABSTRACT

In one embodiment, the present invention includes a method for instrumenting a code block with code to perform dynamic information flow tracking. Then during execution, it may be determined whether a pattern of input data to the code block has been previously received by the code block. If so, the code block may be executed, otherwise the instrumented code block may be executed. Other embodiments are described and claimed.

### BACKGROUND

Embodiments of the present invention relate to computer systems, and more particularly to dynamic information flow tracking in such systems.

As computer systems become more complex, security is becoming of great concern. Authorization and privacy are two major concerns within the security domain. Authorization issues are related to unauthorized access to computer systems or privilege escalation within a system via exploitation of holes in software. Privacy issues are related to access to sensitive data and leaking of such data via access control security holes or propagation.

In an effort to resolve security issues, dynamic information flow tracking has been used to protect systems from authorization violations and compromised privacy. Such flow tracking is typically implemented using a hardware-based approach. These approaches typically include additional hardware support for performing tracking of secure data throughout its lifetime in a system. As an example, data may be tagged with a sensitivity level, which may be located in the dedicated hardware support. During program execution, the system dynamically propagates the sensitivity level for the tagged data and detects violations of user-specified rules. However, by implementing dynamic information flow tracking using a hardware-based approach, legacy systems lacking such specialized hardware cannot perform dynamic information flow tracking. Furthermore, there is added expense and computation complexity in performing a hardware-based dynamic information flow tracking process.

Another issue with respect to current dynamic information flow tracking processes is that they cannot adapt to legacy code. That is, code written without extensions for implementing dynamic information flow tracking cannot take advantage of the hardware support present for such tracking operations.

### BRIEF DESCRIPTION OF THE DRAWINGS

FIG. 1 is a block diagram of a flow of code in accordance with an embodiment of the present invention.

FIG. 2 is a flow diagram of a method in accordance with one embodiment of the present invention.

FIG. 3 is a block diagram of redundant tracking elimination on a block level in accordance with one embodiment of the present invention.

FIG. 4 is a block diagram of redundant tracking elimination on a program region level in accordance with an embodiment of the present invention.

FIG. 5 is a flow diagram of a technique to eliminate redundant tracking in accordance with one embodiment of the present invention.

FIG. 6 is a block diagram of a system in accordance with one embodiment of the present invention.

### DETAILED DESCRIPTION

Embodiments of the present invention may use dynamic binary translation (DBT) to perform dynamic information flow tracking. DBT may be used to convert instructions from a source instruction set architecture (ISA) to a target ISA. A DBT may also perform run-time activities with regard to the translated program. For example, a DBT can instrument and optimize code, and furthermore perform profiling of the run-time behavior of the translated code. Based on such activities, particularly active portions of a program (i.e., hot spots) can be dynamically optimized to improve performance.

In various implementations, a two-phase dynamic binary translator (also referred to herein as DBT) may be used to identify and optimize frequently executed code. More specifically, a first phase (i.e., a profiling phase) may be used to profile the code to determine hot spots within a program. Then in a second phase (i.e., an optimization phase), these hot spots may be optimized in various manners.

Using DBT, flow tracking may be implemented in a pure-software based approach so that the tracking can be performed on machines lacking hardware support for tracking. Furthermore, embodiments may be used to perform dynamic information flow tracking during execution of legacy code (for example, code developed for a 32-bit machine) on more advanced platforms, e.g., a 64-bit machine, although the scope of the present invention is not so limited.

Dynamic information flow tracking in accordance with an embodiment of the present invention may be used to protect various data. For example, in some embodiments some or all user input data may be protected using such flow tracking. Embodiments may further seek to reduce the amount of tracking computation needed based on an analysis of incoming data. Such redundant tracking elimination may be referred to as just enough tracking (JET). More specifically, based upon a pattern of the incoming data, some embodiments may eliminate redundant tracking where a pattern of the input data has been seen previously. Accordingly, upon a first pass of input data into a portion of code, e.g., a basic block, information flow tracking may be performed. A summary of the tracking information computed may be stored upon conclusion of the basic block. Then, when a similar input data pattern is provided to the basic block, information flow tracking may be avoided, as instead the summary corresponding to the input data pattern may be accessed and provided at an output of the basic block.

While described primarily herein with respect to a dynamic binary translation engine, it is to be understood that the scope of the present invention is not so limited and in other embodiments other manners of performing software-based information flow tracking, along with elimination of redundant tracking may be realized.

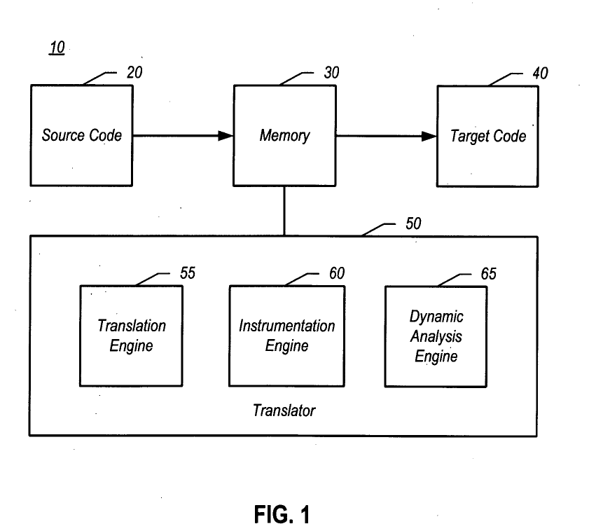

Referring now to FIG. 1, shown is a block diagram of a flow of code in accordance with an embodiment of the present invention. As shown in FIG. 1, an environment 10 may include a memory 30, which in one embodiment may be a dynamic random access memory (DRAM), although the scope of the present invention is not so limited. A source code 20 may be provided to memory 30. For example, source code 20 may correspond to a legacy program, e.g., a program written for a 32-bit machine. As one example, source code 20 may correspond to a source program written in a so-called x86 environment. To execute the program of source code 20 in a different environment, e.g., in a 64-bit environment, source code 20 may be translated into a target code 40, which may be binary translated code for a particular environment.

Still referring to FIG. 1, to perform such binary translation, a translator 50 may be coupled to memory 30. In various embodiments, translator 50 may be a dynamic binary translator (DBT). As shown in FIG. 1, translator 50 may include various engines. In the embodiment of FIG. 1 translator 50 may include a translation engine 55, an instrumentation engine 60, and a dynamic analysis engine 65. While shown with only these engines in the embodiment of FIG. 1 for ease of illustration, additional engines and other functionality may be included in a translator in various embodiments.

Translation engine 55 may be adapted to receive incoming source code 20 and translate it into target code 40. More specifically, translation engine 55 may translate source code 20 into the language used in a given environment to be able to perform the desired operations using the ISA of the target machine.

Instrumentation engine 60 may be used to instrument target code 40 with additional instructions to perform various functions. With respect to embodiments of the present invention, instrumentation engine 60 may be adapted to insert code to perform dynamic information flow tracking. In various embodiments, each target instruction may be instrumented with additional code to perform the information flow tracking. Accordingly, instrumentation engine 60 may generate additional code to be inserted into target code 40. In various embodiments, to avoid the computation expense of performing the instrumented code in every execution, in some embodiments instrumentation engine 60 may generate instrumented code to be stored as a fat block of instrumented code of target code 40, while the original translated code (without instrumentation) may also be stored in target code 40. In this way, when dynamic information flow tracking is not needed for a given code block during execution, the computation expense of executing the instrumented code (e.g., the fat block) can be avoided.

To determine whether or not the instrumented code is to be executed, translator 50 may further include a dynamic analysis engine 65 which may be used to dynamically analyze incoming data to a code block, e.g., a basic block or a trace which may be formed of a plurality of basic blocks. Based on whether a pattern of the input data has been previously seen by a code block, dynamic analysis engine 65 will provide the input data to either the original translated code block in target code 40 or the instrumented fat block in target code 40. While described with this particular implementation in the embodiment of FIG. 1, it is to be understood that the scope of the present invention is not so limited and other embodiments of a dynamic translator may be realized.

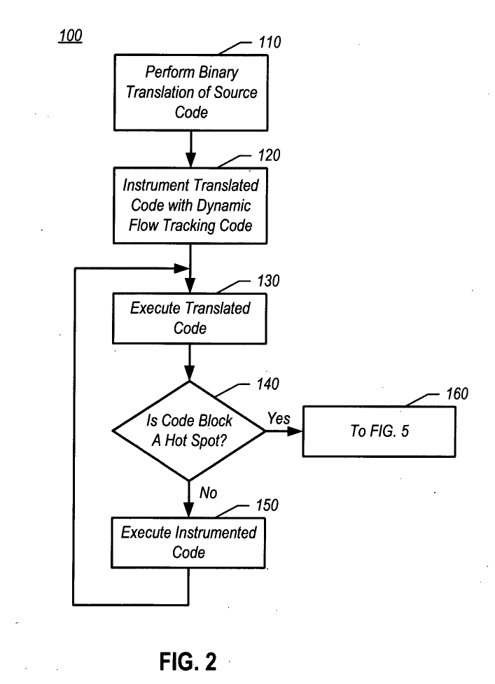

Referring now to FIG. 2, shown is a flow diagram of a method in accordance with one embodiment of the present invention. Method 100 of FIG. 2 may be implemented in a DBT, in various embodiments. As shown in FIG. 2, method 100 may begin by performing binary translation of source code (block 110). For example, a previously compiled program in a source code format (i.e., original code) that includes instructions to be executed on a first platform may be translated into target code including instructions to be executed on a second platform. Accordingly, at block 110, the instructions of the source code are translated to obtain translated instructions of a different target platform (i.e., translated (but uninstrumented) code). Still referring to FIG. 2, next the translated code may be instrumented with additional code to perform various functions (block 120). As an example, the code may be instrumented (i.e., instrumented code) to include instructions to perform counting or other program analysis functions. Furthermore, in various embodiments the code may be instrumented with dynamic flow tracking code. This flow tracking code may be used to associate security or other indicators received with input data and track and perform operations on the indicators as the input data is processed via the code so that upon conclusion of code execution, e.g., of a given basic block, a tracking summary is obtained that may be passed along and used to indicate, e.g., the secure nature of the data being passed from an executed basic block to a next basic block.

After translation and instrumentation, the program (i.e., translated code) corresponding to the target code may be executed (block 130). In various embodiments, a DBT may be used to execute the code on a target platform. During execution of code, it may be determined, e.g., upon entry to a given basic block or other code segment whether the code block is a hot spot (diamond 140). That is, it may be determined whether the code block to be executed has been run more than a selected number of times, as determined by instrumentation code or the like. If it is determined that the code to be executed is not of a hot spot, control passes to block 150. There, the instrumented code may be executed (block 150). Accordingly, a fat instrumented block including flow tracking code may be executed so that upon conclusion of the executed code, data values can be passed to the next code block. Furthermore, a tracking summary corresponding to that data may also be passed to the next code block. In various implementations, the tracking summary may further be stored in a storage. From block 150, control passes back to block 130 for execution of further code, e.g., a next code block.

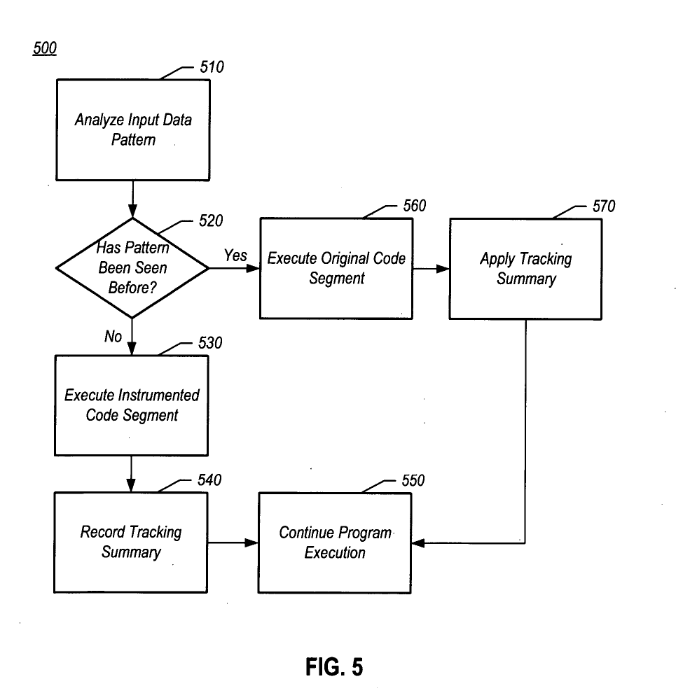

Still referring to FIG. 2, if instead at diamond 140 it is determined that a code block to be executed is a hot spot, control passes to block 160 which will be discussed further below with regard to FIG. 5. As will be discussed further below, FIG. 5 may correspond to code execution that avoids redundancy in dynamic flow tracking. This elimination of tracking redundancy may improve execution speed, as translated but uninstrumented code can be executed in place of instrumented code where an input pattern has been previously seen by a code block. In different implementations, eliminating redundancies in dynamic flow tracking can be done on a per-block basis, e.g., by basic blocks or may be implemented on a larger scale, e.g., on a trace or other program region basis.

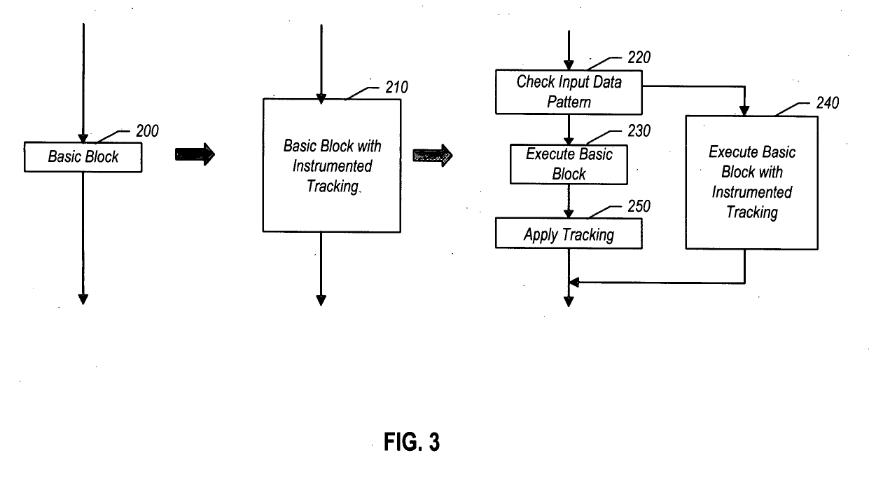

Referring now to FIG. 3, shown is a block diagram of redundant tracking elimination in accordance with one embodiment of the present invention. As shown in FIG. 3, original target code (i.e., translated but uninstrumented code) for a basic block 200 is present. This basic block 200 may be instrumented to obtain an instrumented basic block 210 that includes additional code to perform dynamic flow tracking. By such instrumentation, the complexity and length of the code of basic block 200 is thus expanded. Accordingly to improve performance, embodiments may seek to execute basic block 200 rather than instrumented basic block 210 when flow tracking information is already available for a given input data pattern.

Still referring to FIG. 3, to eliminate redundant tracking, input data, which may include registers as well as live-in memory values, may be analyzed at a beginning of a basic block to determine whether a pattern corresponding to the input data has been seen before by the basic block (block 220). In some embodiments, tracking data associated with these input variables may be analyzed. The tracking data may be indicators that identify a status of the associated variable, e.g., as being secure or non-secure. For example, consider a situation in which five input variables are present with a first two of the input variables being secure data and the final three variables being non-secure data. When later input data having the same assortment of secure and non-secure input data is received, the original basic block 200 (i.e., translated but uninstrumented code) may be executed in place of instrumented basic block 210.

Thus as shown in FIG. 3, based on the pattern of input data, control passes for execution of either the original basic block (block 230) or execution of the instrumented basic block (block 240). As further shown in FIG. 3, after execution of the original basic block (at block 230), control passes to block 250, where a tracking summary is applied (block 250). This tracking summary may be stored in memory and may correspond to tracking data generated when input data having the similar pattern was processed in instrumented basic block 210. From either of blocks 250 and 240, control passes to a next code segment (e.g., a next basic block) (not shown in FIG. 3).

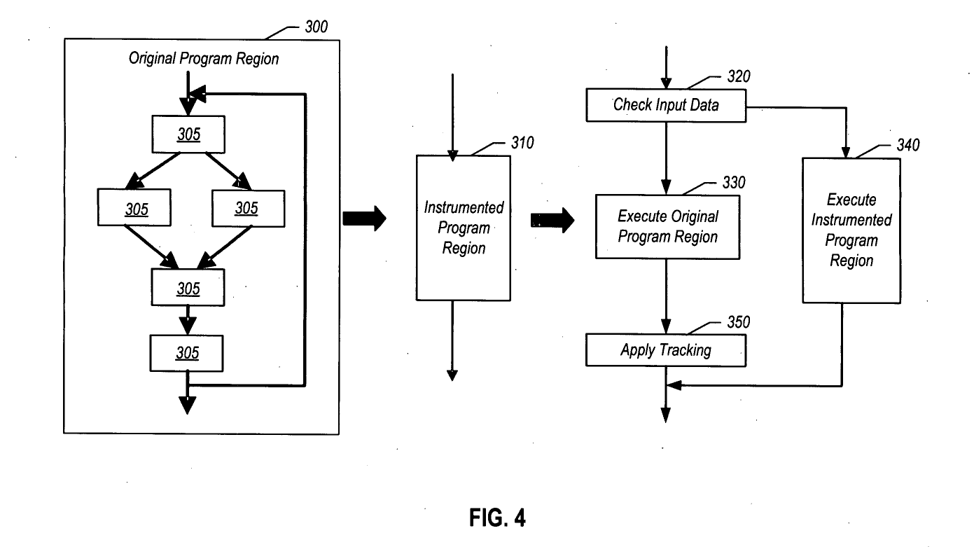

As mentioned above, redundant tracking elimination may further be implemented on a larger scale, e.g., on a program region or trace-level. As an example, a program region may be a collection of basic blocks that are executed frequently, may contain multiple branches, have a single entry point, and may contain multiple exits. Referring now to FIG. 4, shown is a block diagram of redundant tracking elimination on a program region level in accordance with an embodiment of the present invention. Original program region 300, which may be translated but uninstrumented code, may be formed of a plurality of basic blocks 305. As shown in FIG. 4, original program region 300 includes various branches between basic blocks 305 that may be conditionally traversed based on results obtained at a given basic block.

Instrumented program region 310, which may correspond to a fat program region, includes additional code to perform dynamic flow tracking. By such instrumentation, the complexity and length of original program region 300 is thus expanded. Accordingly, when flow tracking information is already available for a given input data pattern to a selected program region, embodiments may seek to execute original program region 300 rather than instrumented program region 310.

Still referring to FIG. 4, input data may be analyzed at a beginning of a program region to determine whether an input pattern corresponding to the input data has been seen before by the program region (block 320). If so, the original program region 300 may be executed in place of instrumented program region 310. In some embodiments, in addition to determining an input data pattern, it may also be determined what paths the program will execute according to an input data set. To do this, trace selection algorithms that may be performed, e.g., using control flow graphs (CFGs) or other such code analysis tools, may be implemented to determined what paths a given code segment will execute based on an input data set.

As further shown in FIG. 4, based on the pattern of input data (and trace selection analysis), control passes for either execution of the original program region (block 330) or execution of the instrumented program region (block 340). In this way, if the input data pattern has been previously seen and the execution path to be taken has also been seen, the original code segment (i.e., the translated but uninstrumented code) may be performed and a tracking summary previously stored may be applied at the one or more exits of the program region. Otherwise, the instrumented program region may instead be executed. As further shown in FIG. 4, after execution of the original program region (at block 330), control passes to block 350, where a tracking summary corresponding to the data pattern is applied (block 350). This summary may include the given input data pattern and corresponding output data pattern, as well as the program execution path taken. From either of blocks 350 and 340, control passes, e.g., to a next code segment (e.g., a next program region or trace).

Referring now to FIG. 5, shown is a flow diagram of a technique to eliminate redundant tracking in accordance with one embodiment of the present invention. As shown in FIG. 5, method 500 may begin by analyzing an input data pattern to a given code segment (block 510). The code segment may correspond to a translated code segment (that has not been instrumented), in some embodiments. Based on the analysis, it may be determined whether a pattern of the input data has been seen before by the code segment (diamond 520). For example, for dynamic information flow tracking implemented with respect to data security measures, the determination may be whether a security pattern of incoming data matches a security pattern of previously seen input data by the code segment. If the input pattern has not been seen before, control passes from diamond 520 to block 530. There, an instrumented code segment may be executed using the incoming data (i.e., program data and tracking data) (block 530). The instrumented code segment may include code to perform dynamic information flow tracking. At the conclusion of the code segment, a tracking summary corresponding to dynamic information flow tracking performed by the instrumented code may be recorded (block 540). For example, each code segment may have one or more entries in a storage medium. Each entry for a code segment may include an input data pattern (e.g., with respect to security values) and a summary corresponding to the output data security values, as determined by code execution when the security pattern is present. Further, entries corresponding to larger program regions may also include an execution path taken. From block 540 control passes to block 550 for continued program execution, e.g., via execution of a next code segment.

If instead at diamond 520 it is determined that an input data pattern has been seen before, control passes to block 560. There, an original code segment (i.e., translated but uninstrumented code) may be executed using the input data (block 560). By executing the original code segment, the expense of performing the instrumented code can be eliminated. At the conclusion of code execution, a tracking summary may be applied (block 570). That is, a tracking summary previously stored (e.g., at block 540) when the corresponding instrumented code block was performed for input data having the same security data pattern may be applied to the output data. Then as discussed above, continued program execution may occur at block 550. While described with this particular implementation in the embodiment of FIG. 5, it is to be understood that the scope of the present invention is not so limited.

Thus according to various embodiments, only a limited amount of flow tracking may be performed based on an input data pattern, i.e., just enough tracking (JET). When used in a DBT, this limited flow tracking may be referred to as just enough tracking dynamic binary translation (JETDBT). In this way, embodiments of the present invention may incur low run-time overhead, allowing a pure software-based dynamic information flow tracking approach. Furthermore, using embodiments of the present invention security may be enhanced for legacy code, e.g., 32-bit code, when that code is translated into a 64-bit environment.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing or transmitting electronic instructions.

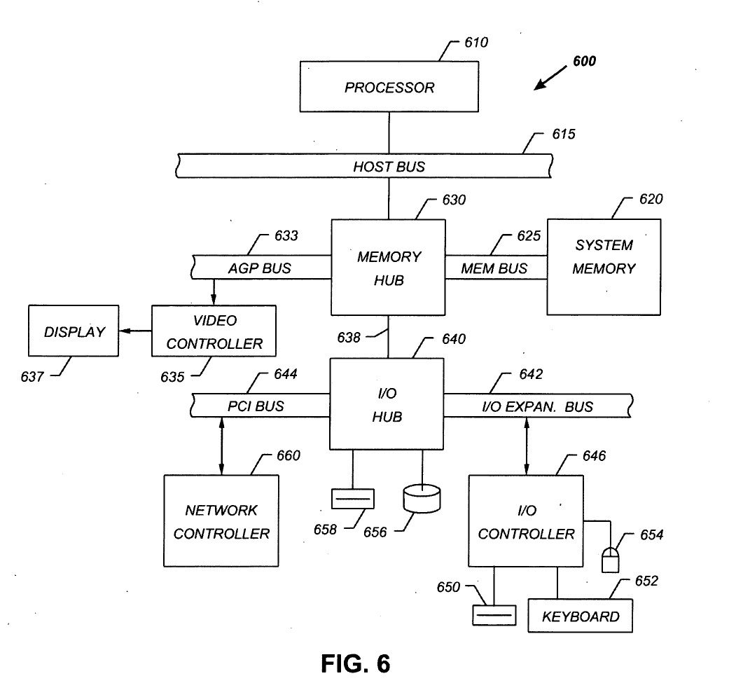

Now referring to FIG. 6, shown is a block diagram of a system in accordance with one embodiment of the present invention. In the embodiment of FIG. 6, a computer system 600 includes a processor 610, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, or the like.

The processor 610 may be coupled over a host bus 615 to a memory hub 630 in one embodiment, which may be coupled to a system memory 620 (e.g., a dynamic random access memory (DRAM)) via a memory bus 625. Programs such as a dynamic binary translator in accordance with an embodiment of the present invention may be stored in system memory 620 during operation, along with program data such as tracking summaries generated during code execution. The memory hub 630 may also be coupled over an Advanced Graphics Port (AGP) bus 633 to a video controller 635, which may be coupled to a display 637 which may be a flat panel display, in some embodiments. The AGP bus 633 may conform to the Accelerated Graphics Port Interface Specification, Revision 2.0, published May 6, 1998, by Intel Corporation, Santa Clara, Calif.

The memory hub 630 may also be coupled (via a hub link 638) to an input/output (I/O) hub 640 that is coupled to a input/output (I/O) expansion bus 642 and a Peripheral Component Interconnect (PCI) bus 644, as defined by the PCI Local Bus Specification, Production Version, Revision 2.1 dated June 1995. The I/O expansion bus 642 may be coupled to an I/O controller 646 that controls access to one or more I/O devices. As shown in FIG. 6, these devices may include in one embodiment storage devices, such as a floppy disk drive 650 and input devices, such as keyboard 652 and mouse 654. The I/O hub 640 may also be coupled to, for example, a hard disk drive 656 and a compact disc (CD) drive 658, as shown in FIG. 6. It is to be understood that other storage media may also be included in the system.

The PCI bus 644 may also be coupled to various components including, for example, a network controller 660 that is coupled to a network port (not shown). Additional devices may be coupled to the I/O expansion bus 642 and the PCI bus 644, such as an input/output control circuit coupled to a parallel port, serial port, a non-volatile memory, and the like.

Although the description makes reference to specific components of the system 600, it is contemplated that numerous modifications and variations of the described and illustrated embodiments may be possible. More so, while FIG. 6 shows a block diagram of a system such as a personal computer, it is to be understood that embodiments of the present invention may be implemented in a wireless device such as a cellular phone, personal digital assistant (PDA) or the like.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
instrumenting a code block to obtain an instrumented code block including code to perform dynamic information flow tracking; and
determining whether a pattern of input data to the code block has been previously received by the code block.

2. The method of claim 1, further comprising:
executing the instrumented code block if the pattern has not been previously received; and
generating and storing a summary of tracking information for the pattern.

3. The method of claim 2, further comprising executing the code block if the pattern has been previously received.

4. The method of claim 3, further comprising obtaining the stored summary of tracking information for the pattern after executing the code block.

5. The method of claim 1, further comprising instrumenting the code block via dynamic binary translation.

6. The method of claim 1, wherein the input data comprises at least one register value and at least one live-in memory value.

7. An apparatus comprising:
an execution unit to execute code; and
a translator coupled to the execution unit, the translator to receive input data including secure information, and to determine whether to provide a first code block or an instrumented code block to the execution unit with the input data based on whether a tracking pattern associated with the input data has been previously received by the translator.

8. The apparatus of claim 7, wherein the execution unit is to generate tracking information for the input data when the execution unit is provided the instrumented code block, wherein the instrumented code block comprises code to perform dynamic information flow tracking to generate the tracking information.

9. The apparatus of claim 8, further comprising a storage to store the tracking information.

10. The apparatus of claim 9, wherein the execution unit is to access the tracking information from the storage when the execution unit is provided the first code block.

11. The apparatus of claim 7, wherein the execution unit is to perform dynamic information flow tracking a single time for the tracking pattern and to generate a tracking summary from the dynamic information flow tracking.

12. The apparatus of claim 11, further comprising a buffer to store the tracking summary, wherein the execution unit is to access the tracking summary if it receives the tracking pattern a second time.

13. An article comprising a machine-accessible medium including instructions that when executed cause a system to:
determine if a security pattern of input data to a code segment has been previously input to the code segment; and
execute an instrumented code segment associated with the code segment using the input data and generate a record of flow information associated with the input data if the security pattern has not been previously input, otherwise execute the code segment using the input data and access the record of flow information.

14. The article of claim 13, further comprising instructions that when executed cause the system to instrument the code segment with tracking code to track flow of the input data through the code segment.

15. The article of claim 14, further comprising instructions that when executed cause the system to instrument the code segment via dynamic binary translation.

16. The article of claim 13, wherein the code segment comprises a plurality of basic blocks.

17. The article of claim 16, further comprising instructions that when executed cause the system to determine a path that the input data is to travel through the plurality of basic blocks.

18. A system comprising:
a processor to execute instructions;
a dynamic translator coupled to the processor, the dynamic translator including a dynamic analysis engine to analyze tracking data associated with an input to a code segment and determine whether to provide the code segment or an instrumented code segment to the processor based on the tracking data; and
a dynamic random access memory (DRAM) coupled to the processor.

19. The system of claim 18, wherein the dynamic translator further comprises an instrumentation engine to instrument the code segment with tracking code to obtain the instrumented code segment.

20. The system of claim 19, wherein the instrumentation engine is to instrument the code segment if the code segment is identified as a hot spot.

21. The system of claim 18, wherein the dynamic translator is to determine a path of the input through the code segment, wherein the code segment comprises a plurality of basic blocks.

22. The system of claim 18, wherein the processor is to generate a tracking summary for the tracking data via execution of the instrumented code segment.

23. The system of claim 22, wherein the processor is to provide the tracking summary with an output of the instrumented code segment.
